(19) United States
(12) Patent Application Publication
(10) Pub. No.: US 2012/0290713 A1
(43) Pub. Date: Nov. 15, 2012

(54) MID-SESSION CHANGE SUPPORT IN USAGE MONITORING

(75) Inventor: Stephen Ellis, Kanata (CA)

(73) Assignee: Alcatel-Lucent Canada Inc., Ontario (CA)

(21) Appl. No.: 13/107,443

(22) Filed: May 13, 2011

(51) Int. Cl. G06F 15/173

(52) U.S. Cl. 709/224

(57) ABSTRACT

Various exemplary embodiments relate to a method and related network node including one or more of the following: receiving, at a session management node, a usage monitoring report from a usage monitoring node, the usage monitoring report including a reported usage amount for a first monitoring key; updating a current usage amount based upon the reported usage amount; identifying a current monitoring key; and requesting additional monitoring from the usage monitoring node for the current monitoring key. Various exemplary embodiments additionally relate to a method and related network node including one or more of the following: taking a policy action based on the current usage amount; determining a next threshold based on the current usage amount; determining a second usage amount associated with a second monitoring key; and adding the current usage amount to at least the second usage amount to determine a total usage amount.

### TECHNICAL FIELD

Various exemplary embodiments disclosed herein relate generally to subscription networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, TS 23.203, and 3GPP TS 29.214 describe the Policy and Charging Rules Function (PCRF), Policy and Charging Enforcement Function (PCEF), and Bearer Binding and Event Reporting Function (BBERF) of the EPC. These specifications also mention a Subscriber Profile Repository (SPR) that interacts with the PCEF through an Sp interface. These specifications further provide some guidance as to how these elements interact in order to provide reliable data services and charge subscribers for use thereof.

### SUMMARY

Various exemplary embodiments relate to a method performed by a session management node for tracking usage in a subscriber network, the method including one or more of the following: receiving, at the session management node, a usage monitoring report from a usage monitoring node, the usage monitoring report including a reported usage amount for a first monitoring key; updating a current usage amount based upon the reported usage amount; identifying a current monitoring key; and requesting additional monitoring from the usage monitoring node for the current monitoring key.

Various exemplary embodiments relate to a session management node for tracking usage in a subscriber network the session management node including one or more of the following: an interface for receiving a usage report from a usage monitoring node, the usage monitoring report including a reported usage amount for a first monitoring key; a usage tracker configured to: update a current usage amount based on the reported usage amount, and identify a current monitoring key; and a message generator configured to request additional monitoring from the usage monitoring node for the current monitoring key.

Various exemplary embodiments relate to a tangible and non-transitory machine-readable storage medium encoded with instructions for execution by a session management node for tracking usage in a subscriber network, the machine-readable storage medium including one or more of the following: instructions for receiving, at the session management node, a usage monitoring report from a usage monitoring node, the usage monitoring report including a reported usage amount for a first monitoring key; instructions for updating a current usage amount based on the reported usage amount; instructions for identifying a current monitoring key; and instructions for requesting additional monitoring from the usage monitoring node for the current monitoring key.

Various embodiments are described wherein the current monitoring key is different from the first monitoring key.

Various embodiments additionally include taking a policy action based on the current usage amount.

Various embodiments additionally include one of more of the following: determining a second usage amount associated with a second monitoring key; and adding the current usage amount to at least the second usage amount to determine a total usage amount, wherein the step of taking a policy action based on the current usage amount comprises taking a policy action based on the total usage amount.

Various embodiments are described wherein the step of requesting additional monitoring from the usage monitoring node for the current monitoring key comprises: determining a next threshold based on the current usage amount; and sending a request message to the session monitoring node including the current monitoring key and the next threshold.

Various embodiments additionally include one of more of the following: determining a second usage amount associated with a second monitoring key; and adding the current usage amount to at least the second usage amount to determine a total usage amount, wherein the step of determining a next threshold based on the current usage amount comprises determining a next threshold based on the total usage amount.

Various embodiments additionally include one or more of the following: receiving an indication that a subscription profile has changed; determining whether the current monitoring key should be changed to a new monitoring key; and if the current monitoring key should be changed to the new monitoring key: disabling the current monitoring key at the usage monitoring node, and setting the current monitoring key to equal the new monitoring key.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary session management node for tracking usage;

FIG. 3 illustrates an exemplary policy set for storing policy data;

FIG. 4 illustrates an exemplary data arrangement for storing subscription information;

FIG. 5 illustrates an exemplary method for processing a usage report; and

FIG. 6 illustrates an exemplary method for changing a monitoring key.

### DETAILED DESCRIPTION

While the 3GPP provides some guidance on usage monitoring at the packet data network gateway (PGW), little detail is provided regarding how the policy and charging rules node (PCRN) should track or otherwise manage reported subscriber usage. Further, the 3GPP does not provide much guidance with regard to properly handling mid-session changes, such as a change to a monitoring key. Accordingly, there exists a need for a PCRN that may efficiently and correctly track usage during mid-session changes.

It should be noted that, while various examples relate to implementations of LTE, as defined by the 3GPP, the devices and methods presented herein may be applicable to other access systems or networks such as, for example, a network access system (NAS). Appropriate modifications will be apparent to those of ordinary skill in the art for implementing these devices and methods in conjunction with alternative access systems and/or networks. It should also be appreciated that while various examples are described with reference to session usage monitoring, the methods described herein may also be applied to flow-level monitoring. Accordingly, as used herein, the term “session” will be understood to encompass both sessions and flows.

Referring now to the drawings, in which like numerals refer to like components or steps, there are disclosed broad aspects of various exemplary embodiments.

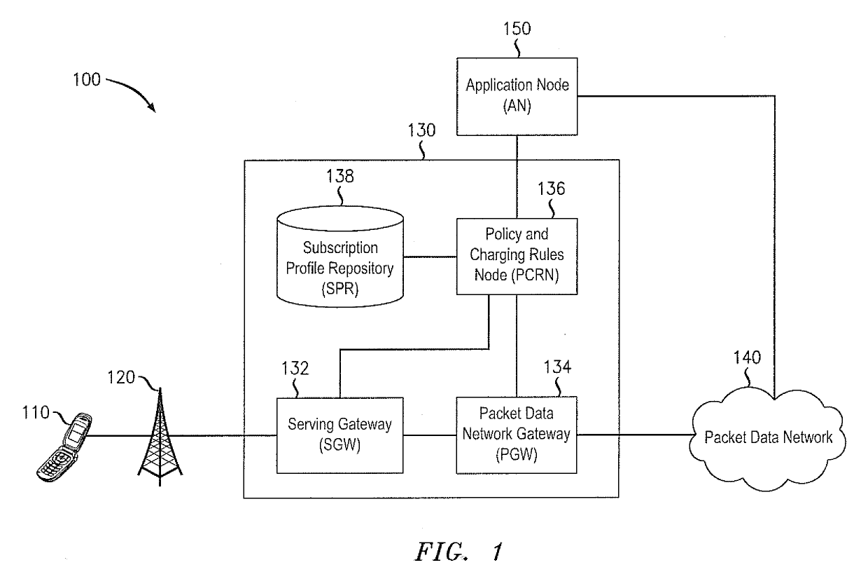

FIG. 1 illustrates an exemplary subscriber network 100 for providing various data services. Exemplary subscriber network 100 may be a telecommunications network or other network for providing access to various services. Exemplary subscriber network 100 may include user equipment (UE) 110, base station 120, evolved packet core (EPC) 130, packet data network 140, and application node (AN) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, tablet, wireless email device, cell phone, smart phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio communication, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with evolved packet core. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be the first device within the EPC 130 that receives packets sent by user equipment 110 and may forward such packets toward PGW 134. SGW 132 may perform a number of additional functions such as, for example, managing mobility of user equipment 110 between multiple base stations (not shown) and enforcing particular quality of service (QoS) characteristics, such as guaranteed bit rate, for each flow being served. In various implementations, such as those implementing the Proxy Mobile IP (PMIP) standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Thus, PGW 134 may be a policy and charging enforcement node (PCEN). PGW 134 may include a number of additional features such as, for example, packet filtering, deep packet inspection, and subscriber charging support.

PGW 134 may also monitor the usage of a number of sessions and/or flows at the instruction of PCRN 136. Thus, PGW 134 may be a member of a class of devices referred to as “usage monitoring nodes.” For each session or flow for which usage monitoring is enabled, PGW 134 may monitor the data transferred until a threshold specified by the PCRN 136 is met. Upon meeting such threshold, the PGW 134 may transmit a usage report to the PCRN 136 indicating that the session or flow has met the specified threshold. Thereafter, PGW 134 may continue to perform usage monitoring for the session or flow until PGW 134 receives additional instruction from the PCRN 136 informing the PGW 134 that usage monitoring is no longer required.

Policy and charging rules node (PCRN) 136 may be a device that receives requests for services, generates PCC rules, and provides PCC rules to the PGW 134 and/or other PCENs (not shown). PCRN 136 may also establish other types of sessions at the request of UE 110 such as, for example, IP Connectivity Access Network (IP-CAN) sessions and/or gateway control sessions. PCRN 136 may receive requests from AN 150 via an RX interface, from SGW 132 via a Gxx interface, and/or from PGW 134 via a Gx interface. Upon receipt of a service request, PCRN 136 may generate or modify at least one PCC rule for fulfilling the service request. PCRN 136 may communicate with SPR 138 via the Sp interface, or other data query mechanisms such as Lightweight Directory Access Protocol (LDAP), when creating PCC rules. PCRN 136 may, for example, use SPR 138 to obtain subscriber service data and/or to coordinate messages from multiple sources. In view of the session management function performed by PCRN 136, PCRN 136 may be a member of a class of devices referred to as “session management nodes.”

Upon creation or modification of a PCC rule or upon request by the PGW 134, PCRN 136 may provide a PCC rule to PGW 134 via the Gx interface. In various embodiments, such as those implementing the PMIP standard for example, PCRN 136 may also generate QoS rules. Upon creation or modification of a QoS rule or upon request by the SGW 132, PCRN 136 may provide a QoS rule to SGW 132 via the Gxx interface.

PCRN 136 may also instruct PGW 134 to monitor the usage for particular sessions and/or flows. Thus, PCRN 136 may calculate the next usage threshold for each session (or flow) to be monitored and instruct the PGW 134 to monitor usage and report to the PCRN 136 once a threshold is met. Upon receiving a usage report indicating that a particular usage threshold has been met, PCRN 136 may take one or more policy actions such as, for example, sending a warning message, reducing quality of service, or terminating service. If additional thresholds have not yet been met, PCRN 136 may also send another instruction to continue monitoring usage at the PGW 134 by indicating the next applicable threshold.

Under various circumstances, PCRN 136 may change a monitoring key associated with usage monitoring for a session or flow. In such cases, PCRN 136 may send a message to PGW 134 to disable the old monitoring key. PGW 134 may then send a usage report for the old monitoring key, which PCRN 136 may store. PCRN 136 may then transmit a request to continue monitoring usage for the session or flow, but may include the new monitoring key instead of the old monitoring key. To ensure that usage is properly tracked in light of the monitoring key change, PCRN 136 maintains a record, either locally or in SPR 138, of the usage reported under each monitoring key for a particular subscription. Thereafter, if the total usage is needed, for example to apply a policy or determine a next applicable usage threshold, the usage for each applicable monitoring key may be added together.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136, may constitute an independent node within EPC 130, or may be a combination of both. SPR 138 may also be distributed across a network, with some components within EPC 130 and other components connected via a network.

SPR 138 may store a subscription record for a number of subscribers. Each subscription record may include a number of subscription identifiers such as, for example, an IPv4 address, an IPv6 address, an international mobile subscriber identity (IMSI), a network access identifier (NAI), a circuit identifier, a point-to-point protocol (PPP) identifier, and a mobile subscriber ISDN (MSISDN) number. Each subscription record may additionally include subscription parameters such as, for example, bandwidth limits, charging parameters, subscriber priority, and subscriber service preferences.

Note that in various alternative embodiments, subscriber network 100 may include a User Data Repository (UDR) (not shown) in lieu of SPR 138. Such a UDR may include similar data to that contained in the SPR 138. Various modifications to the techniques described herein will be apparent in order to provide interoperation between PCRN 136 and a UDR.

Packet data network 140 may be any network for providing data communications between user equipment 110 and other devices connected to packet data network 140, such as AN 150. In various embodiments, packet data network 140 may include the Internet. Packet data network 140 may further provide, for example, phone and/or Internet service to various user devices in communication with packet data network 140.

Application node (AN) 150 may be a device that includes an application function (AF) and provides an application service to user equipment 110. Thus, AN 150 may be a server or other device that provides, for example, a video streaming or voice communication service to user equipment 110. When AN 150 is to begin providing application service to user equipment 110, AN 150 may generate a request message, such as an authorization and authentication request (AAR) according to the Diameter protocol, to notify the PCRN 136. This request message may include information such as an identification of the subscriber using the application service and an identification of the particular service data flows that must be established in order to provide the requested service. AN 150 may communicate such an application request to the PCRN 136 via the Rx interface.

Various services may be requested, and subsequently established, based on an AAR sent to PCRN 136 by AN 150, based on a CCR sent to the PCRN 136 by PGW 134 or SGW 132, or based on a combination thereof. For example, PCRN 136 may receive an AAR and a CCR both requesting a particular service for a particular user. Accordingly, the PCRN 136 is adapted to determine that two request messages are associated with the same session and process the messages accordingly. For example, the PCRN 136 or a Diameter Proxy Agent (not shown) may use a session binding identifier (SBI) to determine that a request message is related to a previously received request message. Thus, PCRN 136 may establish a session based on an initial request message and subsequently modify the session based on the supplemental request message.

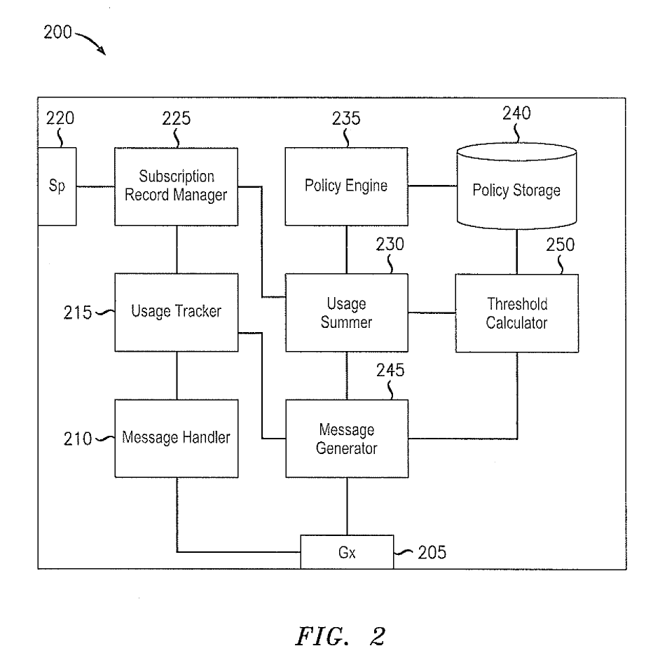

FIG. 2 illustrates an exemplary session management node 200 for tracking usage. In various embodiments implementing the LTE standard, session management node 200 may be a PCRN such as PCRN 136. Exemplary session management node 200 may include Gx interface 205, message handler 210, usage tracker 215, Sp interface 220, subscription record manager 225, usage summer 230, policy engine 235, policy storage 240, message generator 245, and threshold calculator 250. It will be apparent that various components may be specific to implementations of particular standards and that various modifications may be appropriate for implementation of alternative standards.

Gx interface 205 may be an interface comprising hardware and/or executable instructions encoded on a machine-readable storage medium configured to communicate with other network nodes such as, for example, PGW 134 using the Diameter protocol. Accordingly, Gx interface 205 may be adapted to transmit RAR and CCA messages and to receive RAA and CCR messages.

Message handler 210 may include hardware and/or executable instructions on a machine-readable storage medium configured to receive and process various messages via Gx interface 205. Message handler 210 may receive usage reports from usage monitoring nodes such as PGW 134. Such usage reports may carry an active monitoring key and may indicate that a particular session (or flow) has reached a particular threshold. Accordingly, message handler 210 may forward such information to usage tracker 215 for processing. Message handler 210 may handle various additional types of messages such as, for example, requests for IP-CAN session establishment and/or policy and charging control (PCC) rules.

Usage tracker 215 may include hardware and/or executable instructions on a machine-readable storage medium configured to maintain reported usage data. For each received usage report, usage tracker 215 may request a subscription record from subscription record manager 225. This subscription record may include previously recorded usage for various monitoring keys. To record the usage report, usage tracker 215 may read the reported monitoring key from the usage report and locate the field associated with the reported monitoring key in the subscription record. Usage tracker 215 may then add the reported usage to the field and send the subscription record back to subscription record manager for storage.

Usage tracker 215 may further be configured to maintain a current monitoring key for each monitored session. Accordingly, usage tracker 215 may include or communicate with a session storage (not shown) that stores data associated with sessions and/or flows managed by session management node 200. Usage tracker 215 may determine that the current monitoring key for a session should change under some circumstances. For example, usage tracker 215 may receive an indication that a subscription record has been changed. Other circumstances wherein it may be appropriate to change a current monitoring key will be apparent to those of skill in the art. Usage tracker 215 may determine a new monitoring key for a session or flow by applying one or more rules. For example, if a subscription tier changes from “Silver” to “Gold,” usage tracker 215 may determine that the current monitoring key, “SilverKey” should change to “GoldKey.” Accordingly, usage tracker 215 may include or communicate with a rules engine (not shown) for determining an appropriate monitoring key. Once usage tracker 215 determines the new monitoring key, usage tracker 215 may store it as the current monitoring key for the session and/or flow and notify the message generator 245 that the current monitoring key for the session and/or flow has changed.

Sp interface 220 may be an interface comprising hardware and/or executable instructions encoded on a machine-readable storage medium configured to communicate with other network nodes such as, for example, SPR 138 using the Diameter protocol. Accordingly, Sp interface 220 may be adapted to transmit requests for subscription records and to receive subscription records. In various alternative embodiments, session management node 200 may include a local SPR. In such embodiments, Sp interface 220 may not be present. In other alternative embodiments, SPR 138 may instead be accessible via LDAP. In such embodiments, Sp interface 220 may be replaced by an LDAP interface (not shown).

Subscription record manager 225 may include hardware and/or executable instructions on a machine-readable storage medium configured to retrieve and store subscription records via the Sp interface 220. Subscription record manager 225 may receive one or more subscription identifiers from usage tracker 215 and/or usage summer 230 and retrieve an associated subscription record. Further, subscription record manager 225 may receive one or more subscription records from usage tracker 215 and/or usage summer 230 and transmit the records to an SPR for storage and future retrieval. Subscription record manager 230 may further include a subscription record cache (not shown). Thus, copies of subscription records may be stored locally at session management node 200 and written back to an SPR periodically.

Usage summer 230 may include hardware and/or executable instructions on a machine-readable storage medium configured to determine a total usage amount associated with a session or flow. In the case where a monitoring key has changed for a session or flow, the usage associated with that session or flow may be recorded in different locations in association with the different monitoring keys that have been used. Accordingly, usage summer 230 may retrieve a subscription record from subscription record manager 225, determine which monitoring keys are relevant to total usage for the session or flow, and add the values associated with those monitoring keys in the subscription record. Usage summer 230 may identify the relevant monitoring keys by, for example, reading the policy set associated with the session from policy storage 240. Such policy may identify the keys relevant to the session or flow. Once usage summer 230 determines a total usage amount, usage summer 230 may provide this value to policy engine 235, threshold calculator 250, and/or message generator 245.

Policy engine 235 may include hardware and/or executable instructions on a machine-readable storage medium configured to apply various policies to sessions, as defined in policy storage 240. Upon receiving usage report information regarding a particular session, policy engine 235 may request a total usage for the session from usage summer 230. In various alternative embodiments, usage summer may automatically provide such total usage information to policy engine 235 upon calculation. Using the total usage amount, the policy engine may determine and apply an appropriate policy.

Policy storage 240 may be any machine-readable medium capable of storing data related to usage policies. Accordingly, policy storage 240 may include a machine-readable storage medium such as read-only memory (ROM), random-access memory (RAM), magnetic disk storage media, optical storage media, flash-memory devices, and/or similar storage media.

Message generator 245 may include hardware and/or executable instructions on a machine-readable storage medium configured to generate various messages for transmission to other nodes such as PGW 134. Upon receiving an indication from message handler 210 that a particular session or flow has reached a threshold and/or upon receiving an indication from usage tracker 215 that usage data has been updated, message generator 245 may request the next applicable threshold for the session from threshold calculator 250. Message generator 245 may then generate a message informing the appropriate usage monitoring node of the new threshold to be monitored and the current monitoring key.

Message generator 245 may also receive an indication from usage tracker when a current monitoring key for a session is to be changed. Upon receiving such an indication, message generator 245 may first generate a message instructing the session management node to disable the current monitoring key (before it is changed to the new monitoring key). Message generator 245 may further generate additional types of messages under appropriate circumstances such as, for example, instructions to install or modify a PCC rule.

Threshold calculator 250 may include hardware and/or executable instructions on a machine-readable storage medium configured to determine the next applicable threshold for a particular session or flow. Upon request for such information from message generator 245 or policy engine 235, threshold calculator 250 may request the total usage for the session or flow from usage summer 230. In various alternative embodiments, usage summer 230 may automatically provide the total usage to threshold calculator 250 upon calculation. Using the total usage, threshold calculator 250 may examine the applicable policy set stored in policy storage 240 to determine the lowest threshold that has not yet been reached. Threshold calculator 240 may then return this information to the requesting component.

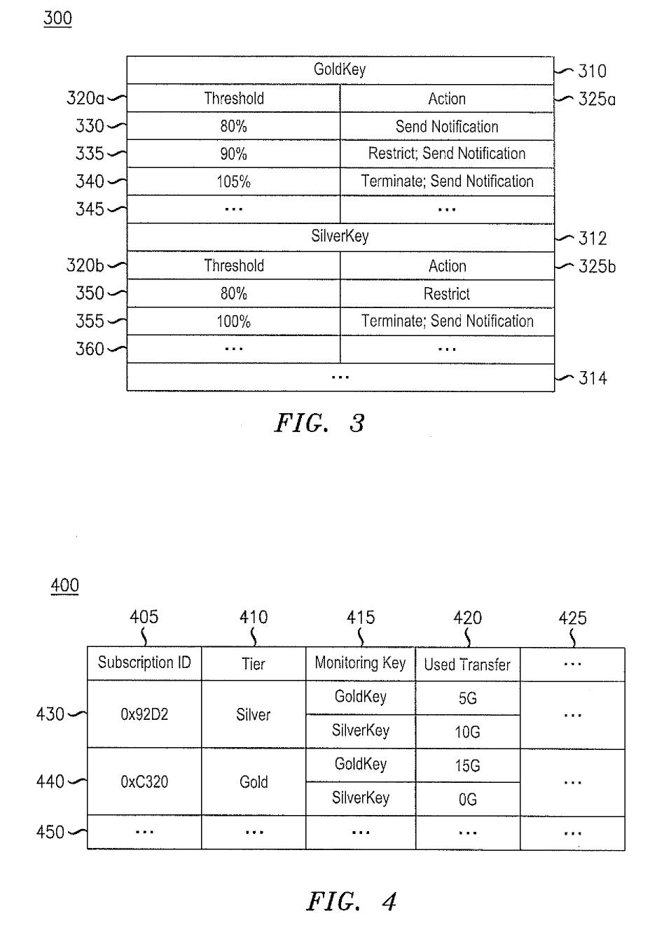

FIG. 3 illustrates an exemplary policy set 300 for storing policy data. Policy set 300 may be a table in a database or cache such as policy storage 240. Alternatively, policy set 300 may be a series of linked lists, an array, or a similar data structure. Thus, it should be apparent that policy set 300 is an abstraction of the underlying data; any data structure suitable for storage of this data may be used.

A session management node such as session management node 200 may have access to multiple policy sets such as policy set 300 that are to be used in different contexts. For example, policy set 300 may be applicable to subscriber A, while a different policy set may be applicable to subscriber B. As another example, policy set 400 may be applicable during weekdays between 7 AM and 7 PM while another policy set may be applicable at all other times (in this example, during nights and weekends).

Policy set 300 may include a number of policy subsets such as policy subset 310 and policy subset 312. Policy set 300 may include a number of additional policy subsets 314. Each policy subset may be associated with one or more monitoring keys. For example, policy subset 310 is associated with the monitoring key “GoldKey.” As another example, policy subset 312 may be associated with monitoring key “SilverKey.” In this example, policies that belong to a particular subset may be applicable when one of the associated monitoring keys is the current monitoring key for the session. Usage accrued in connection with any monitoring key associated with policy set 300, however, may be applicable to the defined thresholds. Thus, for policy set 300, usage connected with “GoldKey” and “SilverKey” may be added for purposes of determining an applicable policy, regardless of the current monitoring key. It should be understood that policy set 300 may be an abstraction of a data arrangement actually implemented. For example, when implemented, each individual policy 330, 335, 340, 345, 350, 355, 360 may individually identify any monitoring keys to which that policy applies.

Each policy subset may further include a number fields such as threshold field 320a,b and action field 325a,b. Threshold field 320a,b may indicate a usage amount at which a particular policy is applicable. For example, threshold field 320a,b may indicate a percentage of a usage limit or other value at which a policy is applicable. Alternatively, threshold field 320a,b may indicate a literal usage value such as, for example, “40G.” Action field 325a,b may indicate one or more actions that should be taken when a particular policy is applicable. Such action may include, for example, sending a notification to one or more nodes or altering the characteristics of a session or flow.

As an example policy 330 indicates that, when “GoldKey” is active and when a session has reached 80% of their maximum usage amount, the session management node should send a notification to the user. As another example, policy 335 indicates that, when “GoldKey” is active and when a session has reached 90% of their maximum usage amount, the session management node should restrict the QoS bandwidth and send a notification to the user. Likewise, policies 340 indicate additional thresholds and actions to be taken when “GoldKey” is active, while policies 350, 355 indicate additional thresholds and actions to be taken when “SilverKey” is active. Policy subsets 310, 312 may include numerous additional policies 345, 360.

FIG. 4 illustrates an exemplary data arrangement 400 for storing subscription information. Data arrangement 400 may be a table in a database or cache such as SPR 138 and/or subscription record manager 225. Alternatively, data arrangement 400 may be a series of linked lists, an array, or a similar data structure. Thus, it should be apparent that data arrangement 400 is an abstraction of the underlying data; any data structure suitable for storage of this data may be used. Data arrangement may include a number of fields such as subscription ID field 405, tier field 410, monitoring key field 415, and used transfer field 420. Data arrangement 400 may contain numerous additional fields 425 to store data such as, for example, usage limits, subscriber category, subscriber name, guaranteed bitrates, maximum bitrates, and aggregate maximum bitrate.

Subscription ID field 405 may store a unique identifier for each subscription records. In various embodiments, each subscription record may be associated with multiple subscription identifiers. In such embodiments, data arrangement 400 may include additional fields (not shown) for each such identifier.

Tier field 410 may store a current subscription tier for each subscription. For example, a service provider may offer different subscription plans at different prices. In this example, a gold tier may be more expensive and provide better performance than a silver tier.

Monitoring key field 415 may store a monitoring key for each subscription record. Such a monitoring key may be used to identify the threshold limits within a particular session or flow in the communications between a usage monitoring node and a session management node. For example, each time either the PGW 134 or PCRN 136 transmits a message including the Usage-Monitoring-Information AVP, a monitoring key may be included to identify the session or flow threshold limit to which the AVP applies. Each subscription record may be associated with multiple monitoring keys. Accordingly, there may be a one-to-many relationship between subscription id field 405 and monitoring key field 415.

Used transfer field 420 may indicate the amount of data actually transferred for a particular subscription within a period of time and while a particular monitoring key was enabled. For example, each time a session management node such as session management node 200 receives a usage monitoring report, the session management node may add the usage reported to the value currently stored in the used transfer field 420 for the appropriate monitoring key. The value of used transfer field 420 may be reset to zero periodically such as, for example, at the beginning of every month or other billing period. Alternatively, the used transfer field 420 may be a single field for each subscription records and may indicate a combined usage for all monitoring keys.

As an example, subscription record 430 indicates that subscription ID “0x92D2” is currently on the “Silver” subscription tier. Subscription “0x92D2” is associated with two monitoring keys: “GoldKey” and “SilverKey.” Further, “0x92D2” has used 5G of transfer while “GoldKey” was enabled and 10G of transfer while “SilverKey” was enabled.

As another example, subscription record 440 indicates that subscription ID “0xC320” is currently on the “Gold” subscription tier. Subscription “0xC320” is associated with two monitoring keys: “GoldKey” and “SilverKey.” Further, “0xC320” has used 15G of transfer while “GoldKey” was enabled. “0xC320” has not used any transfer while SilverKey has been active. Data arrangement 400 may include numerous additional subscription records 450.

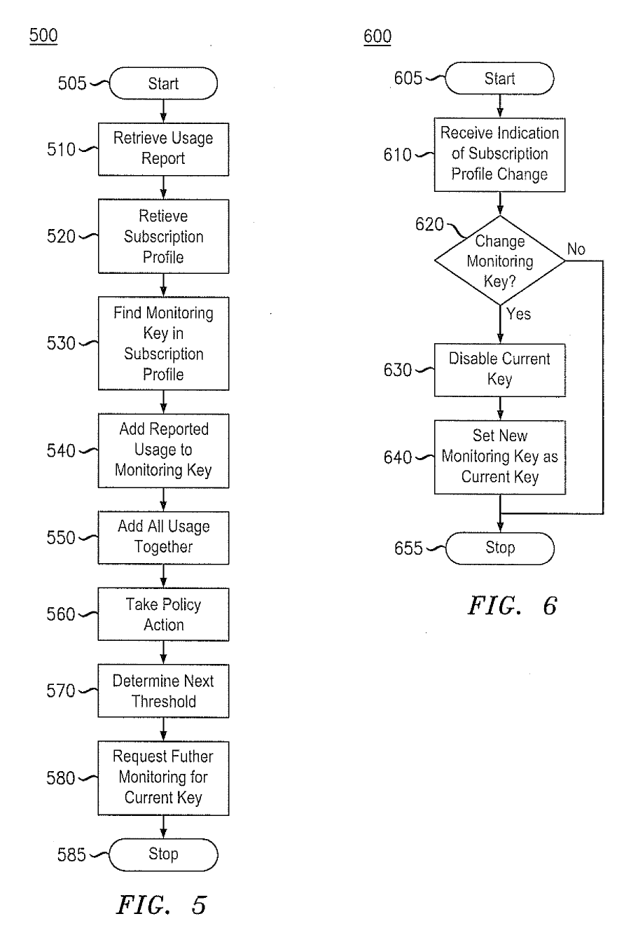

FIG. 5 illustrates an exemplary method 500 for processing a usage report. Method 500 may be performed, for example, by the components of session management node 200 such as message handler 210, usage tracker 215, subscription record manager 225, usage summer 230, policy engine 235, message generator 245, and/or threshold calculator 250.

Method 500 may begin in step 505 and proceed to step 510 where session management node 200 may receive a usage report from a usage monitoring node such as PGW 134. This usage report may be, for example, a credit and control request (CCR) or a reauthorization answer (RAA). Then, in step 520, session management node 200 may retrieve a subscription record associated with the session identified by the usage report. This subscription record may be stored locally or in an external device such as SPR 138. Method 500 proceeds to step 530, where session management node 200 extracts the monitoring key from the usage report and locates the same monitoring key in the subscription record. Once the monitoring key is located, session management node 200 may, in step 530, add the usage amount in the usage report to the usage value previously recorded in the subscription record in association with the monitoring key. Session management node 200 may at this point store the updated subscription record, either locally or at a remote device.

Next, in step 550, session management node 200 may add all usage associated with any relevant monitoring key in the subscription record to determine a total usage value. For example, session management node 200 may sum all reported usage, all, usage associated with a session and/or flow, and/or all usage associated with a monitoring key identified by the applicable policy set. After session management node 200 has calculated the total usage, method 500 may proceed to step 560, where session management node 200 may take a policy action based on the total usage. Such policy action may include, for example, sending a notification, restricting a session and/or flow, and/or terminating a session and/or flow. Method 500 may then proceed to step 570 where, based on the total usage, session management node 200 may determine a next threshold to be crossed by the subscriber. Finally, in step 580, session management node 200 may request further usage monitoring by the usage monitoring node by sending a message including the new threshold and the current monitoring key. Note that in some circumstances, the current monitoring key may be different from the monitoring key in the most recent usage report. Thus, at step 580, session management node 200 may actually enable a new monitoring key at the usage monitoring node. Once the request is sent, method 500 proceeds to end in step 585.

It should be noted that, while method 500 is illustrated as a single process, method 500 could be implemented as multiple cooperating processes and run on parallel processors and/or threads. For example, steps 510, 520, 530, 540, 550 may be implemented as one process, step 560 may be implemented as a second process. And steps 570, 580 may be implemented as a third process. Various alternative implementations of method 500 will be apparent to those of skill in the art.

FIG. 6 illustrates an exemplary method 600 for changing a monitoring key. Method 600 may be performed, for example, by the components of session management node 200 such as usage tracker 215, subscription record manager 225, and/or message generator 245.

Method 600 may begin in step 605 and proceed to step 610, where session management node 200 may receive an indication that a subscription record has changed. For example, an event may be sent by an SPR such as SPR 138 indicating that a subscription record has changed to a different subscription tier. It should be apparent that various additional stimuli for changing a monitoring key could be implemented. For example, instead of a change to a subscription record, session management node 200 may instead receive an indication from a traffic management node that a session is suspected of including malicious traffic. Numerous additional stimuli will be apparent to those of skill in the art.

Based on the indication received in step 610, session management node may determine whether a monitoring key should be changed in step 620. Session management node 200 may, for example, consult a rules engine which, in turn, may apply various context information to a rule set to determine an appropriate monitoring key to use for a session and/or flow. If the monitoring key should not change, method 600 may proceed directly to end in step 655. If however, the monitoring key should be changed, method 600 may instead proceed to step 630.

In step 630, session management node 200 may disable the current monitoring key at the session management node. For example, session management node may generate a reauthorization request (RAR) indicating that monitoring for the current key should be disabled and subsequently transmit the RAR to the usage monitoring node. Next, in step 640, session management node 200 may set the new monitoring key as the current monitoring key for the session or flow. For example, session management node 200 may store the monitoring key in association with a locally-stored session or flow object. Thereafter, any operations performed with respect to the “current monitoring key” will be performed with respect to the new monitoring key.

Method 600 may then proceed to end in step 655. It will be noted that method 600 ends without enabling the new monitoring key at the usage monitoring node. In various embodiments, after session management node 200 disables the then-current monitoring key in step 630, the usage management node may respond by sending a usage report detailing the usage accrued since the last usage report. Accordingly, such action may initiate method 500 in session management node 200. Thus, in response to the usage report; session management node 200 may transmit a request for additional monitoring with respect to the current monitoring key in step 580.

In various alternative embodiments, method 600 may also include steps similar to steps 550 and 560 of method 500. Accordingly, method 600 may include the application of a policy. For example, if the change of monitoring key renders a policy applicable that has an already-met threshold, session management node 200 may apply that policy during method 600.

Having described exemplary components and methods for the operation of exemplary subscriber network 100 and session management node 200, an example of the operation of exemplary subscriber network 100 and session management node 200 will now be provided with reference to FIGS. 1-6. For the purposes of this example, session management node 200 may correspond to PCRN 136; policy set 300 may indicate the contents of policy storage 240; data arrangement 400 may indicate the contents of SPR 138; and methods 500, 600 may describe the operation of session management node 200.

As shown by subscription record 440, subscription “0xC320” is currently a gold tier subscription and has used 15G of transfer. For the purposes of this example, it will be assumed that subscription “0xC320” is associated with a 50G usage limit. Thus, “0xC320” has used 30% of this limit. The next applicable policy for “0xC320,” provided that the applicable policy set or subset does not change, will be policy 330, because policy 330 is associated with the monitoring key “GoldKey” and the lowest unmet threshold. Thus, PGW 134 may currently be monitoring usage in association with “GoldKey” and a threshold of 25G (80% of 50G, less the previously reported 15G).

It should be noted that in various embodiments, PGW 134 may retain usage information for various sessions. In such embodiments, thresholds may be reported without subtracting previously observed and/or reported usage. Thus, in such an embodiment, PGW 134 may currently be monitoring usage in association with “GoldKey” and a threshold of 40G (80% of 50G).

At some point before PGW 134 observes 25G of transfer and sends a usage report, the subscriber associated with subscription “0xC320” indicates that the subscription tier should be dropped to the silver tier. Accordingly, tier field 410 of subscription record 440 is changed to “Silver.” Subsequently, subscription record manager 225 receives an indication that the record has changed in step 610. Usage tracker 215 may determine that the current monitoring key should now be “SilverKey” in step 620. Accordingly, message generator 245 may send a RAR to PGW 134 indicating that monitoring should be disabled for “GoldKey” and usage tracker may store “SilverKey” as the current monitoring key for the session in steps 630, 640, respectively.

Upon receiving the RAR, PGW 134 may disable monitoring and send a usage report indicating that 10G of transfer have been observed since the last usage report. The usage report is received by session management node 200 in step 510. Subscription record manager 225 retrieves subscription record 440 in step 520. In steps 530, 540, usage tracker 215 adds the reported usage (10G) to the previously recorded usage for “GoldKey” (15G). Accordingly, subscription record 440 may indicate that 25G of usage have been observed for “GoldKey.” Next, in step 550, usage summer 230 may add all previously recorded usage together to determine the total usage for the session. Thus, the 25G associated with “GoldKey” and the 0G associated with “SilverKey” are added to generate a total usage of 25G. Assuming that the change to subscription tier did not change the usage limit for subscription “0xC320,” 50% of the usage limit has been used. Policy engine may determine, in step 560, that no policy is applicable to this level of usage and, accordingly, take no action. In step 570, threshold calculator 250 may determine that the next applicable policy will likely be policy 350 because it is the lowest unmet policy that is associated with “SilverKey,” the current monitoring key. Thus, the next applicable threshold will be met after 15G of transfer (80% of the 500 limit, less the 25G of already-used transfer). Accordingly, in step 580, message generator 245 may transmit a CCA to PGW 134 indicating that usage should be monitored for the session in association with the current monitoring key, “SilverKey.”

Some time later, PGW 134 transmits a usage report in the form of a CCR indicating the 15G of transfer has been observed since the last usage report. As before, session management node 200 updates subscription record 440 to include the 15G of usage in connection with “SilverKey.” Again, in step 540, usage summer 230 determines the total usage; this time, the total usage calculated by adding the 25G of usage associated with “GoldKey” to the 15G of usage associated with “SilverKey” to yield a total usage of 40G, or 80% of the usage limit. In step 560, policy engine 235 determines that policy 350 should be applied because “SilverKey” is active and the 80% threshold has been met. Accordingly, policy engine 235 may take action to restrict one or more sessions or flows associated with the subscription “0xC320.” Now, in step 570, usage summer determines that the next applicable policy 355 will apply after 10G more transfer is observed. Accordingly, message generator 245 sends another CCR to PGW 134, this time indicating that usage should be monitored in connection with “SilverKey” and that a usage report should be sent after 10G of transfer is observed.

According to the foregoing, various exemplary embodiments enable proper tracking of usage before and after a mid-session change. In particular, by storing usage in association with a number of different monitoring keys, usage may be stored separately and later summed when appropriate such as, for example, when applying a policy or determining a next applicable threshold.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a session management node for tracking usage in a subscriber network, the method comprising:
receiving, at the session management node, a usage monitoring report from a usage monitoring node, the usage monitoring report including a reported usage amount for a first monitoring key;
updating a current usage amount based upon the reported usage amount;
identifying a current monitoring key; and
requesting additional monitoring from the usage monitoring node for the current monitoring key.

2. The method of claim 1, wherein the current monitoring key is different from the first monitoring key.

3. The method of claim 1, further comprising taking a policy action based on the current usage amount.

4. The method of claim 3, further comprising:
determining a second usage amount associated with a second monitoring key; and
adding the current usage amount to at least the second usage amount to determine a total usage amount,
wherein the step of taking a policy action based on the current usage amount comprises taking a policy action based on the total usage amount.

5. The method of claim 1, wherein the step of requesting additional monitoring from the usage monitoring node for the current monitoring key comprises:
determining a next threshold based on the current usage amount; and
sending a request message to the session monitoring node including the current monitoring key and the next threshold.

6. The method of claim 5, further comprising:
determining a second usage amount associated with a second monitoring key; and
adding the current usage amount to at least the second usage amount to determine a total usage amount,
wherein the step of determining a next threshold based on the current usage amount comprises determining a next threshold based on the total usage amount.

7. The method of claim 1, further comprising:
receiving an indication that a subscription record has changed;
determining whether the current monitoring key should be changed to a new monitoring key; and
if the current monitoring key should be changed to the new monitoring key:
disabling the current monitoring key at the usage monitoring node, and
setting the current monitoring key to equal the new monitoring key.

8. A session management node for tracking usage in a subscriber network the session management node comprising:
an interface for receiving a usage report from a usage monitoring node, the usage monitoring report including a reported usage amount for a first monitoring key;
a usage tracker configured to:
update a current usage amount based on the reported usage amount, and
identify a current monitoring key; and
a message generator configured to request additional monitoring from the usage monitoring node for the current monitoring key.

9. The node of claim 8 wherein the current monitoring key is different from the first monitoring key.

10. The node of claim 8, further comprising a usage summer configured to:
determine a second usage amount associated with a second monitoring key; and
add the current usage amount to at least the second usage amount to determine a total usage amount.

11. The node of claim 8, further comprising a policy engine configured to take a policy action based on the current usage amount.

12. The node of claim, further comprising a threshold calculator configured to determine a next threshold based on the current usage amount,
wherein, in requesting additional monitoring from the usage monitoring node for the current monitoring key, the message generator is configured to send a request message to the session monitoring node including the current monitoring key and the next threshold.

13. The node of claim 8, further comprising subscription record manager configured to receive an indication that a subscription record has changed;
wherein the usage tracker is configured to, in response to the indication that a subscription record has changed, determine whether the current monitoring key should be changed to a new monitoring key; and
wherein the message generator is configured to, if the usage tracker determines that the current monitoring key should be changed to the new monitoring key, disable the current monitoring key at the usage monitoring node.

14. A tangible and non-transitory machine-readable storage medium encoded with instructions for execution by a session management node for tracking usage in a subscriber network, the machine-readable storage medium comprising:
instructions for receiving, at the session management node, a usage monitoring report from a usage monitoring node, the usage monitoring report including a reported usage amount for a first monitoring key;
instructions for updating a current usage amount based on the reported usage amount;
instructions for identifying a current monitoring key; and
instructions for requesting additional monitoring from the usage monitoring node for the current monitoring key.

15. The tangible and non-transitory machine-readable storage medium of claim 14, wherein the current monitoring key is different from the first monitoring key.

16. The tangible and non-transitory machine-readable storage medium of claim 14, further comprising instructions for taking a policy action based on the current usage amount.

17. The tangible and non-transitory machine-readable storage medium of claim 16, further comprising:
instructions for determining a second usage amount associated with a second monitoring key; and
instructions for adding the current usage amount to at least the second usage amount to determine a total usage amount,
wherein the instructions for taking a policy action based on the current usage amount comprise instructions for taking a policy action based on the total usage amount.

18. The tangible and non-transitory machine-readable storage medium of claim 14, wherein the instructions for requesting additional monitoring from the usage monitoring node for the current monitoring key comprise:
instructions for determining a next threshold based on the current usage amount; and
instructions for sending a request message to the session monitoring node including the current monitoring key and the next threshold.

19. The tangible and non-transitory machine-readable storage medium of claim 18, further comprising:
instructions for determining a second usage amount associated with a second monitoring key; and
instructions for adding the current usage amount to at least the second usage amount to determine a total usage amount,
wherein instructions for determining a next threshold based on the current usage amount comprise instructions for determining a next threshold based on the total usage amount.

20. The tangible and non-transitory machine-readable storage medium of claim 14, further comprising:
instructions for receiving an indication that a subscription record has changed;
instructions for determining whether the current monitoring key should be changed to a new monitoring key; and
instructions for, if the current monitoring key should be changed to the new monitoring key:
disabling the current monitoring key at the usage monitoring node, and
setting the current monitoring key to equal the new monitoring key.
